(19) United States
(12) Patent Application Publication
(10) Pub. No.: US 2010/0072835 A1
(43) Pub. Date: Mar. 25, 2010

(54) Stacking Method For Electric Machines

(75) Inventor: Frederick William Klatt, Bedford, MA (US)

Correspondence Address: FREDERICK W. KLATT, 30 FOXRUN RD., BEDFORD, MA, 01730, US

(73) Assignee: Frederick William Klatt, Bedford, MA (US)

(21) Appl. No.: 12/586,700

(22) Filed: Aug. 6, 2009

Related U.S. Application Data
(60) Provisional application No. 61/093,372, filed on Sep. 1, 2008.

(51) Int. Cl. H02K 1/18; H02K 1/28; H02K 11/00; H02K 9/19; H02K 15/02

(52) U.S. Cl. 310/54; 310/216.113; 310/71; 29/598

(57) ABSTRACT

Stacking more than one electric machine module (i.e., electromagnetic electric motor or generator system) with all stator bodies commonly attached and all moving bodies commonly attached increases the overall power of the stack according to the sum of power rating of each module in the stack. A keying object means comprises complementary keys on the stator and rotor bodies that allow easy mating alignment of at least two autonomous electric machine modules in the stack and preserve the mechanical integrity so all modules in the stack move or act as one large electric machine. Furthermore as an integral component in the manufacturing process of the electric machine module, the keying object means serves as an alignment mechanism for precision manufacture of the module chassis without precision methods, such as precision machining, or precision materials, or precision pieces, such as castings.

### PRIOR ART

Stacking electric machine (i.e., electromagnetic motor or generator) systems of various (or similar) power rating back-to-back is a sure way of providing multiple increases in overall power rating of the stack. Multiple electric machine systems could be directly connected to a internal common shaft, which is at least as long as the stack, or indirectly connected to a common extraneous shaft through an arrangement of pulleys and belts. All methods described require a degree of manual adjustment to align the chassis and shafts. The stacking methods described may add real estate and mechanical complexity to the installation but if the electric machines are of the same variety, stacking allows a single inventory of electric machines with a given power rating, a single support base, and a single knowledge base. The patent (US 2009/0167104) of Randy B. Dunn stacks electric machine systems with all electric machines in the stack connected to a single common internal shaft. Furthermore, Dunn stipulates the adjacent surfaces between stack electric machines are without protuberances or features that would preclude tightly adjacent electric machines. As a result, Dunn's patent must incorporate a large common shaft that meets the length and torque requirements of the total stack, which poses considerable challenge for field assembly or disassembly (for repair) of the stack.

Conventional manufacture of the electric machine module requires: 1) separate manufacture of the electromagnetic core, which includes the slotted magnetic steel core for windings, of the stator and rotor assemblies; 2) separate manufacture of the chassis or structural frame that holds the core aligned with the shaft to guarantee air-gap alignment; and finally, 3) assembly of the components, such as windings, bearings, etc. As a result, the chassis or structural frame is precision machined from bulk material, casted and then precision machined, or precision casted. Effectively, the chassis or structural frame becomes the precision assembly mechanism (i.e., jig) for assembling and aligning the components, such as the electromagnetic core.

As used herein, “electric machine” is an electric motor or electric generator, which includes a stator assembly with electromagnetic core, a rotor assembly with magnetic or electromagnetic core, and a bearing assembly that allows a dimensionally confined air-gap between the stator and rotor assemblies with non-conflicting movement between rotor and stator assemblies.

As used herein, “module” or “electric module” or “electric machine module” is a single electric machine entity in the stack.

As used herein, “stacking” is connecting more than one electric machine (i.e., electric motor or generator) system or electric machine module to form a common electric machine entity of larger power rating.

As used herein, the “stator assembly,” and the “rotor assembly” are the two major components of the electric machine module. These “module assemblies” comprise the winding set, any permanent magnet assembly, the chassis, and the electrical steel core.

As used herein, “stack” is the culmination of stacking at least two electric machine modules.

### OBJECT OF THE INVENTION

One object of the present invention is to provide at least one keying object means for ease of connecting, aligning, assembling or mating at least two electric machine modules together (to make a stack of modules) that preserves the static and dynamic mechanical integrity throughout the stack, such as torque, force, power, while mitigating any anomalies of the connection (i.e. mating), such as vibration or misalignment.

As used herein, the “keying object means” or “keying object” comprises a “key protrusion object” on one mating surface that matches (and mates to) a “key insertion object” on the other mating surface, which is the complementary mirror image of the key protrusion object, while providing structural integrity, alignment, and vibration damping of the complementary mating surfaces and the entire stack when the key protrusion object is inserted into the key insertion object.

As used herein, “mechanical integrity” refers to both static and dynamic mechanical integrity, which further includes alignment tolerance, vibration tolerance, and, etc.

Another object of the invention is to include a polymer, plastic, spring-like, or composite material, or a spring or spring-like arrangement with the keying object means to further mitigate (i.e., damp) the effects of any imperfection in alignment. The damping means, which is the polymer, plastic, spring-like, or composite material, or the spring or spring-like arrangement, may be placed between the surfaces of the key protrusion object and the key insertion object of the keying object means or may be an integral part of the keying object means.

As used herein, the “damping” or “vibration damping” means comprises a polymer, plastic, spring-like, or composite material, or a spring or spring-like arrangement to mitigate imperfections in structural alignment that may result in vibration or mating problems, which may be separately applied or integral with the keying object means.

A further object of the invention is to integrate the keying object means into a manufacturing mechanism or jig that is an integral part of the manufacturing tooling of the electromagnetic core of the electric machine module; thereby, providing a precision jig for direct manufacture and integration of the chassis or structural frame with the electromagnetic core. Furthermore, the keying object means and integral jig allow the use of less precise structural material, such as sheet metal, angle iron, etc., and less precision tooling, such as welding, since the manufacturing jig is the precision alignment mechanism.

As used herein, the “chassis” comprises the “structural frame” that holds the electromagnetic core (i.e., the core and windings) of the stator and rotor assemblies and the air-gap alignment between the rotor and stator assemblies.

As used herein, “mating” is connecting at least two electric machines (i.e., electric motor or generator system) together as a common electric machine or stack of electric machine modules.

As used herein, “mating surface” is the interface between at least two electric machine modules of the stack and is the surface where the key protrusion objects or the key insertion objects are located. The “mating surface” includes the surfaces of the rotor and stator assemblies because these surfaces essentially occupy the same reference plane, although the rotor and stator surfaces are disconnected and move relative to each other. Each electric machine module connection in the stack has at least two mating surfaces with complementary keying object arrangement for mating at least two electric machine modules together as a common electric machine entity in a stack.

A further object of the invention is to realize a stack of multiple electric machines, where each electric machine in the stack is standalone (i.e., autonomous) and without a single common or solid shaft connecting the entire stack. Without a common shaft over the length of the stack, each electric machine can be individually separated from the stack, regardless of stack position, with a slight separation of the mating surfaces for easy field assembly or repair.

A further object of the invention is to utilize the keying objects means as isolated or insulated connection for the flow of electricity or for the flow of cooling medium, such as for cooling liquids, between stacked electric machines.

A further object of the invention effectively increases the total air-gap area by the number of electric machines stack lengthwise, which allows axial flux machines with a fixed air-gap cross-sectional area per machine diameter on a radial plane to effectively increase air-gap area by extending the stack of electric machine modules lengthwise.

Another object of the invention is to simplify shipping and assembly logistics for high power electric machines. As one example, this inventor is proposing the idea of stacking more than one axial flux (i.e., pancake style) electric generator with a common power rating longitudinally in the nacelle of a wind turbine with the total power rating of the stack the sum of each electric machine in the stack. As a result, each electric generator module in the stack or even the stator and rotor assemblies of the module is within the handling capacity of the internal crane of the nacelle. The modules or assemblies can be individually hoisted to the nacelle by an internal nacelle crane and then stacked or assembled in the nacelle for the final electric generator component of the wind turbine electric drive train and with the combined power capacity of all modules. The stack of modules becomes a very large and powerful generator that would be beyond the handling capacity of the internal crane; particularly, for low speed, large diameter electric machines. The hoisting of small sized modules can greatly reduce the cost complexity, and risk associated with alternatively hoisting a single large generator by a large crane hauled to the site.

### BRIEF DESCRIPTION OF THE DRAWINGS

FIG. 1 illustrates one example of mating two electric machine modules with the keying object means of this invention. The keying object means shown in the FIGURE is provided by rods (or dowels) as key protrusion objects that align the modules as the rods are inserted into their respective key insertion objects, which in this example are holes drilled into the opposite mating surface at the same location and arrangement as the key protrusion objects. The key insertion objects and the key protrusion objects are complementary styles. It should be obvious that the keying object means can be any shape, form, or size as long as the alignment and static and dynamic mechanical constraints of the stack are satisfied. The keying object means could have a pointed end, such as a needle or missile, a torpedo shape, or the like to further add initial alignment ease of mating the two modules. Furthermore, the keying object could essentially be an integral part of the chassis, such as complementary shapes stamped into the mating surfaces. Each electric machine module in the stack of this invention is autonomous and without connection to a common shaft that spans the length of the stack.

### DETAILED DESCRIPTION OF THE INVENTION

Stacking more than one electric machine module into a common stack of modules will accumulate the power of all electric machine (electric generator or motor) modules in the stack. For this invention, the stacking of modules requires the mating surfaces to be keyed with protrusions and insertions so the mating of the modules is predetermined (obvious) and simple, while preserving the alignment and the static and dynamic mechanical integrity of the entire stack, such as the accumulated torque of the entire stack. Once mated, all moving bodies become one and all stationary bodies become one, while allowing independent movement between the stack of rotor bodies (i.e., moving bodies) and the stack of stator bodies (i.e., stationary bodies). Regardless, the alignment of the module surfaces can never be perfect and as a result, the mating surfaces will show some wobble (or vibration) relative to each other. This may require the keying object means to include a damping means, such as a plastic, polymer, composite, spring like, etc. material or spring or spring-like action to complement the keying object means to be placed between the surfaces of the keying object means, such as a sleeve, or at the mating surfaces of the modules to absorb any imperfection or wobble between modules of the stack while preserving the transfer of torque, force or power between the modules. Furthermore, the damping means may be an integral part of the mating surface or the keying object means for the purpose just discussed.

The stacking method of this invention allows an electric machine of large power rating to be compartmentalized with the accumulation of smaller autonomous modules, which can be easily shipped and then assembled lengthwise along the stack at the field site. This is especially advantageous for large machines to be installed in logistically difficult locations, such as installing the generator component in the nacelle of a large wind turbine, which is high from the ground. In this specific case, each module assembly (rotor or stator section of a pancake or axial flux electric machine module) or the entire electric machine module could be hoisted to the nacelle using an internal crane, which is designed for the weight and size of a single electric machine module (or even the stator or rotor section of the module) of the stack, and thereby allowing the electric machine to be assembled in the nacelle to realize the final large generator. Furthermore, no common shaft with considerable weight and size to satisfy the combine length and torque rating of the combined stack is needed or lifted.

Fully electromagnetic machines (i.e., electric machines without permanent magnets) can be lifted as either individual module components (e.g., rotor and stator components) or entire modules while permanent magnet electric machines are better lifted as entire modules because of the logistics of persistent flux permanent magnets. In all cases, there must be real estate allotted in the nacelle and an installation mechanism in the nacelle for assembling the modules into the final electric machine stack, which is considerable less real estate than would be needed for a stack with a common shaft. The assembly mechanism could be a common mounting frame with rails or dollies or a simple crane, such as the internal nacelle crane.

Stacking allows for lower inventory of electric machine module styles or sizes, since large machines can evolve from stacking a single style of electric machine module. Stacking reduces engineering, machine tooling, and tooling real-estate (i.e., manufacturing real estate), since limited module types and sizes are designed and built for different size electric machines. In some cases, the rotor and stator electromagnetic core and winding bodies can be identical entities, which further reduces inventory. Furthermore, stacking effectively increases the total air-gap area by the number of electric machines stacked lengthwise, which allows axial flux machines with a fixed radial-diameter air-gap cross-sectional area per machine module to effectively increase the air-gap area by extending the stack lengthwise with multiple electric machines.

The electric machine module can be any type or category. The electric machine module can be axial flux (pancake form-factor) or radial flux (traditional cylinder inside an annulus form-factor) or trapezoidal flux, although the examples and figures are axial flux. The electric machine module can be linear or rotating, although the examples and figures are rotating. Preferably, the electric machine module is an axial flux (or pancake) design because stacking of commonly sized modules will grow longitudinally in a more manageable and predictable fashion. Furthermore, it may be advantageous to separate or gap the mating surfaces between electric machine modules to equally expose all mating surfaces to ambient or for active removal of heat by forcing coolant, such as pressurized air or wind, through the gap between the mating surfaces.

The shape of the keying object means can be any, such as round shape, star shape, spoke shape, trapezoid shape, square shape, rectangle shape, etc. The only requirement is that the key protrusion objects, which is on one mating surface, and the key insertion object, which is on the other mating surface, are complementary (or mirror) shapes to allow connection of the keying object means and to hold and align the mating surfaces as one, while preserving the static and dynamic mechanical integrity of the stack. Furthermore, the keying object means can be an integral part of the mating surface, which could be the result of machining, stamping, or casting the keying object means directly onto the mating surfaces, or the keying object means can be attached to the mating surface, such as by means of welding or bolting, such as welding or bolting a bracket. Each keying object means on the rotor assembly or the stator assembly can differ, as long as the arrangement of unlike keying object means allows mating of the modules and serves the purpose of alignment, mechanical integrity, and keying polarity.

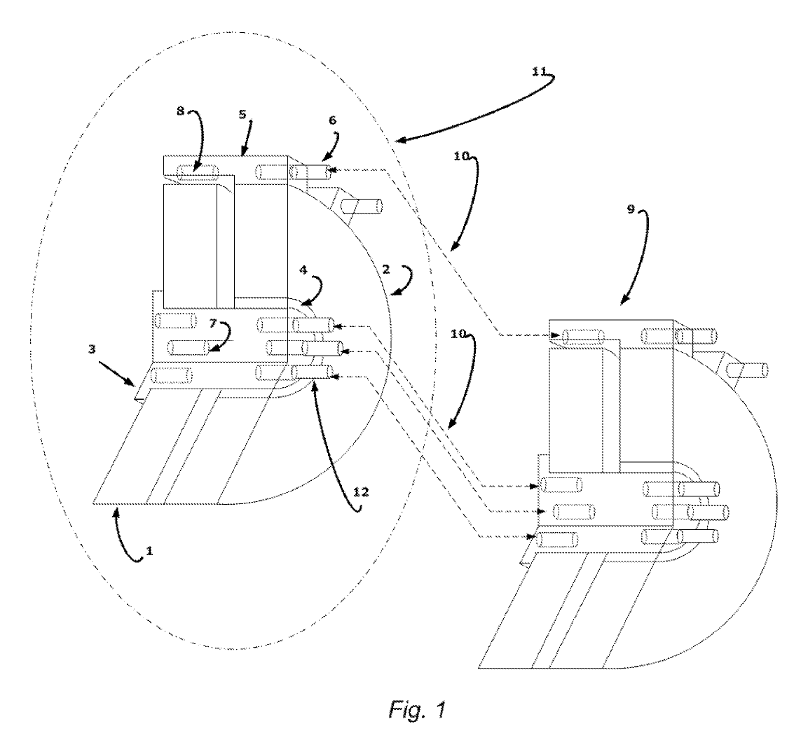

FIG. 1 shows one example of the keying object means. FIG. 1 shows the path 10 of the keying object means when mating one module 9 to another module 11. Each electric machine module consists of a rotor assembly 1 and a stator assembly 2 with a rotor attached spindle 3 and bearing assembly 4 to allow rotation between the rotor assembly 1 and stator assembly 2. It is noted the entire module is a representation of the electric machine and may not convey the most optimum or complete electromagnetic or mechanical design, arrangement, or configuration; particularly, for the bearing spindle 3, which may be integral to the rotor assembly, and bearing 4 assemblies. It is further noted that each electric machine module is autonomous (i.e., standalone) and without the need of a common shaft that connects to all modules in the entire stack and is at least as long as the stack itself. Instead, the keying object means is used to connect both the stator assemblies and the rotor assemblies between electric machine modules in the stack. For this example, the keying object means consists of dowels (or rods) as the key protrusion objects 6 & 12 and holes as the key insertion objects 8 & 7. The key protrusion objects 6 & 12 and the key insertion objects 8 & 7 are complementary mirror images or form-factors; that is to say, the key protrusion objects inserts with precision into the key insertion objects. In this example, the key protrusion objects 6 of the stator assembly 2 and the key insertion objects 8 of the stator assembly 2 are integral components of brackets 5, which are integrally or strategically attached around the circumference of the stator assembly 2. [A full arrangement of brackets along the perimeter of the stator assembly and subsequently, all keying object means are not shown to simplify the drawing.] Likewise in this example, the key protrusion objects 12 of the rotor assembly 1 and the key insertion objects 7 of the rotor assembly 1 are integral components of the spindle (or shaft) 3 of the rotor assembly, which are strategically placed around the circumference of the spindle 3. [All rotor assembly keying object means are not shown to simplify the drawing.] The number of key protrusion objects 6 & 12 and the number or size of complementary key insertion objects 8 & 7 or brackets 5 depends on the degree of static or dynamic mechanical integrity required, such as overall force, alignment, or torque. It is noted that shapes, other than dowels and holes, respectively, can be used for the keying object means as long as the key protrusion object and the complementary key insertion object mate together with insertion. Further, the key protrusion object and key insertion object, respectively, can be an integral part of the rotor assembly or stator assembly, such as machined or casted into the chassis of the rotor assembly or the stator assembly. It should be further understood that additional modules, not shown, could be subsequently stacked, which would require opposite mating surfaces of the electric machine module to have the complementary keying object means (as is shown). Not shown are damping means, which may be installed or integrated between the mating surfaces or between the key protrusion object and key insertion object to mitigate alignment anomalies. Not shown is a possible “housing” that protects the entire stack from the surrounding environment while adding structural integrity, such as holding the stack together, or helping with passive or active cooling of the stack within the housing. It is noted that the stator 2 and rotor 1 assemblies or the mating surfaces for the protrusion 6 & 12 and insertion 8 & 7 keys could be reversed with similar results. Furthermore, both mating surfaces of the electric machine modules could be designed with insertion keys only but before mating the surfaces, the protrusion keys would be inserted into the insertion keys of one mating surface and as a result, the mating surface becomes the mating surface with the protrusion keys.

As used herein, the “first mating surface” and the “second mating surfaces” are the opposing mating surfaces at the common mating interface between adjacent electric machine modules in the stack where the arrangement of keying objects reside. Both the first mating surface and the second mating surface include a rotating surface and a stationary surface with keying objects on the rotating and stationary surfaces. Therefore, every electric machine module has a designated first and second mating surface on opposite sides of the electric machine module and as a result, the first mating surface and second mating surfaces are interchangeable terms that designate opposite surfaces of an electric machine that perpendicular to the electric machine axis or axle.

It is noted that the bearing assembly 4 means, which includes the common assembly of bearings and races, can be placed towards the outer circumference or even along the outer surface but between the two core bodies 2 & 1 and within brackets 5 as a bearing support to keep the dimensions of the air-gap surfaces aligned during movement. This bearing surface could replace or supplement the bearing assembly depicted by 3 & 4. Furthermore, the bearing means would be substantially different from the bearing assembly 4 to avoid conflict with the electromagnetic core of the electric machine, which is not shown. For instance, the bearing means could be precision wheels with perhaps axle and bearings that run along a flat surface or wheel raceway.

As used herein, the “bearing assembly means” is an assembly of generally precision components that allow dimensionally confined but free movement between the rotor and stator assembly to preserve the air-gap dimensions during static and dynamic conditions. The components may consist of roller bearings, taper bearings, thrust bearings, wheels, axles, races, spindles, bearing chassis, etc., which are custom designed and assembled or purchased off-the-shelf.

Noted again, there is no common shaft over the length of the stack but instead, the autonomous shaft of each electric machine module is connected by keying objects. The entire shaft of the stack effectively becomes a plurality of shafts interconnected back to back by the keying object means. It is also noted that the autonomous axles of each electric machine must be capable of supporting the combined torque of the expected stack. Without the common shaft over the length of the stack, each electric machine can be individually separated from the stack regardless of position in the stack for easy field assembly or repair by slightly separating the mating surfaces of the module and then removing the module in question from the stack. With a common shaft, all electric machine modules up to and including the module in question would need to move across the entire common shaft before removal, which is an operation not easily performed in the field or in confined spaces.

Each electric machine module in the stack may be electrically connected in series for higher voltage rating of the stack or in parallel for higher current rating of the stack. With the appropriate isolation or insulation, the keying object means can function as paths for electrical connections (i.e., electricity) or for cooling medium connections, such as for cooling liquid, between electric machine modules in the stack.

The keying object means can serve another purpose. As a precision structural element of the electric machine module, the precision arrangement of the keying object means can similarly be applied as an integral method of manufacturing the chassis for the stator or rotor winding assembly. Just as the keying object means precisely aligns the mating surfaces of at least two electric machine modules, the keying object means could similar be applied to a precision manufacturing mechanism or jig for holding the precise alignment during integration of various raw structural pieces of the chassis for the stator or the rotor assembly. Since the precision manufacturing jig forms the precision alignment of the chassis components or structural pieces through the arrangement of complementary keying object means situated on the jig, only the key protrusion objects or the key insertion objects need precision machining in raw components that become part of the chassis and determine the precision of the chassis. Since all keying objects (i.e., either the insertion object or the protrusion object) of the chassis are precision aligned with their complementary keying object on the jig, less precise raw structural material or pieces, such as sheet metal, angle iron, etc., can be attached using less precise methods, such as welding. The alignment of the pieces, such as brackets, spindles, etc., is preserved by the precision manufacturing jig with its precision keying objects and the precision keying objects integrated into the specific raw component pieces. As a result, the finished chassis is precision aligned with the keying object means, which preserves the principle of electric machine module alignment when mating, but the structure or frame is constructed with raw components and without a completely pre-machined or casted precision chassis, which is the conventional method. It is understood that this method makes chassis manufacture and integration inexpensive and just-in-time but may require balancing for rotation or movement because of the imprecision of the structural pieces. Even the electromagnetic core of the rotor or stator assembly of the electric machine module, which would be precisely aligned to the keying objects of the manufacturing jig, can be attached using non-precision methods, such as welding, gluing, etc. to the raw components of the chassis. Furthermore, the principles of the manufacturing jig (or the manufacturing jig) can be integrated into the manufacturing tool of the electromagnetic core and now the manufacturing tool plays the part of manufacturing the electromagnetic core and the chassis at one station.

As used herein, “keying object jig” is a precision manufacturing assembly jig for the manufacture of electric machine modules that incorporates the complementary image of the arrangement of keying object means of the rotor or stator assembly of an electric machine module to be manufactured. The jig allows the precise holding and alignment of the raw (i.e., non-precise) structural material or pieces of the chassis for at least less precision attachment method, such as welding. The jig could be integrated into the core tooling.

The keying object jig adds another degree of manufacturing flexibility that reduces the manufacturing cost and the end cost of the product. For instance, the keying object jig could be another ingredient for just-in-time core manufacturing tooling. The method of manufacturing would include: (step 1) add or integrate the keying object jig to the magnetic core manufacturing tool; (step 2) manufacture the magnetic core; (step 3) manufacture the chassis onto the core by using the keying object jig for precision alignment of the chassis components or pieces.

I claim:

1: A method for mating at least two electric machine modules together in a stack comprising the four steps of:
a) Incorporate at least one keying object comprising a key protrusion object on the first mating surface of the common mating interface between said electric machine modules of said stack and a key insertion object on the second mating surface of the common mating interface between said electric machine modules of said stack;
b) Align said key protrusion object with said key insertion object;
c) Move said first mating surface and second mating surface together with said key protrusion object inserted into said key insertion object;
d) Lock together said electric machine modules of said stack with attachment hardware selected from a group consisting of housings, brackets, welds, pins, keys, bolts, nuts, clamps, welds, and bearing assemblies:
whereby the alignment of said first mating surface with said second mating surface of said common mating interface between said electric machine modules is held with static and dynamic mechanical integrity by said keying objects and said attachment hardware;
Wherein all stator bodies of said electric machine modules in said stack are act as one;
Wherein all rotor bodies of said electric machine modules in said stack act as one and move together relative to said stator bodies;
Whereby all said electric machine modules in said stack function as one;
Whereby the overall power rating of said stack of said electric machine modules is the sum of the power ratings of said electric machine modules in said stack.

2: The combination defined in claim 1, wherein said first mating surface and said second mating surface of said common mating interface between said electric machine modules have similar arrangements and styles of said keying object further selected from a group consisting of positions, shapes, sizes, and mating surface configurations.

3: The combination defined in claim 1, wherein said keying object provides vibration damping to preserve said alignment and said mechanical integrity.

4: The combination defined in claim 1, wherein said keying object provides at least one isolated connection path for electricity flow between said first mating surface and said second mating surface of said common mating interface between said electric machine modules of said stack.

5: The combination defined in claim 1, wherein said keying object provides at least one isolated connection path for cooling medium flow between said first mating surface and said second mating surface of said common mating interface between said electric machine modules of said stack.

6: A method for manufacturing a precision chassis assembly for the stator assembly and the rotor assembly of an electric machine module comprising the four steps of:
a) Incorporate a manufacturing jig comprising at least one keying object selected from a group consisting of key protrusion objects and key insertion objects:
Wherein said keying object of said manufacturing jig is precisely complementary to the arrangements, positions, shapes, sizes, and surface configuration of said keying object of said chassis assembly to be manufactured;
b) Incorporate the complement of said keying object of said manufacturing jig into the raw components of said chassis assembly of said electric machine module to be manufactured further selected from a group consisting of rotor assembly and stator assembly:
Wherein said incorporation only include said raw components which mate to said keying object of said manufacturing jig;
c) Install said raw components with said complement of said keying objects onto said keying object of said manufacturing jig:
Wherein said raw components are precisely position and held in the foot print of said chassis assembly to be manufactured by said manufacturing jig;
d) Attach said raw components installed on said keying object of said manufacturing jig with raw structural components for completing said chassis assembly to be manufactured:
Wherein said raw structural components are selected from a group consisting of precision and non-precision raw materials;
Whereby said remaining raw structural components together with said installed raw components form said chassis assembly are precisely aligned with said manufacturing jig.

6: The combination defined in claim 6, wherein said attaching of said raw components to said raw structural components is further selected from a group consisting of welding, brazing, sintering, fusing, and gluing.

7: The combination defined in claim 6, wherein said manufacturing jig is integral with the manufacturing tool of the electromagnetic core further selected from a group consisting of rotor and stator core electromagnetic core of said electric machine module:
Wherein said electromagnetic core is first manufactured with said manufacturing tool;
Wherein the air-gap surface of said electromagnetic core is pre-aligned to the precision surface of said manufacturing tool and said integral manufacturing jig;
Wherein said electromagnetic core is included with said raw components;
Whereby said chassis assembly becomes a precision structural frame of said rotor and stator electromagnetic core of said electric machine module.
